(19) United States
(12) Patent Application Publication
(10) Pub. No.: US 2025/0091257 A1
(43) Pub. Date: Mar. 20, 2025

(54) METHOD OF RECOVERING CARBON FIBERS

(71) Applicants: NISSAN MOTOR CO., LTD., Yokohama-shi (JP); TOKYO INSTITUTE OF TECHNOLOGY, Tokyo (JP)

(72) Inventors: Asuka SAKAI, Kanagawa (JP); Masatoshi KUBOUCHI, Tokyo (JP); Winarto KURNIAWAN, Tokyo (JP)

(73) Assignees: NISSAN MOTOR CO., LTD., Yokohama-shi (JP); TOKYO INSTITUTE OF TECHNOLOGY, Tokyo (JP)

(21) Appl. No.: 18/888,513

(22) Filed: Sep. 18, 2024

(30) Foreign Application Priority Data
Sep. 19, 2023 (JP) 2023-150781

(51) Int. Cl. B29B 17/02; B29K 307/04; C01B 32/05; C08J 5/04; D01F 9/12

(52) U.S. Cl. CPC B29B 17/02; C01B 32/05; C08J 5/042; D01F 9/12; B29B 2017/0293; B29K 2307/04; C01P 2002/82; C01P 2002/85; C01P 2004/03; C01P 2004/04; C08J 2300/00; D10B 2505/02

(57) ABSTRACT

To suppress damage to recycled carbon fibers (deterioration of the recycled carbon fibers), the present disclosure includes a first treatment step of immersing carbon fiber reinforced plastic in an acidic aqueous solution to dissolve at least a part of resin content of the carbon fiber reinforced plastic and a second treatment step of immersing a treated product subjected to the first treatment step in an alkaline aqueous solution having foaming properties to dissolve at least a part of resin content of the treated product.

### TECHNICAL FIELD

The present invention relates to a method of recovering carbon fibers from carbon fiber reinforced plastic.

### BACKGROUND ART

As a method of recycling carbon fibers from waste carbon fiber reinforced plastic, a method is known, which includes immersing a carbon fiber composite material in an acidic aqueous solution such as a nitric acid aqueous solution having a concentration of 6 M and then immersing the carbon fiber composite material in an alkaline aqueous solution such as a sodium hydroxide aqueous solution having a concentration of 2.5 M (Patent Document 1).

### PRIOR ART DOCUMENTS

### Patent Documents

[Patent Document 1] JP2019-136932A

### SUMMARY OF INVENTION

### Problems to be Solved by Invention

In the above conventional recycling method, however, an alkaline aqueous solution having a high concentration, preferably about 0.1 to 10 M, is used, and there is therefore a problem in that the recycled carbon fibers may be damaged, resulting in deterioration of the recycled carbon fibers.

A problem to be solved by the present invention is to provide a method of recovering carbon fibers that is able to suppress damage to recycled carbon fibers.

### Means for Solving Problems

The present invention solves the above problem through immersing carbon fiber reinforced plastic in an acidic aqueous solution and then immersing the treated product in an alkaline aqueous solution having foaming properties.

### Effect of Invention

According to the present invention, it is possible to suppress the damage to recycled carbon fibers.

### BRIEF DESCRIPTION OF DRAWINGS

FIG. 1A is a diagram illustrating a method of preparing a sample from a waste carbon fiber reinforced plastic part for an automobile;

FIG. 1B is a diagram illustrating a method of treating the sample with an acidic aqueous solution;

FIG. 1C is a diagram illustrating a method of treating the sample with an alkaline aqueous solution;

FIG. 1D is a diagram illustrating a method of recovering carbon fibers from a treated sample;

FIG. 2A is a SEM photograph showing the recycled carbon fibers of Comparative Example 1;

FIG. 2B is a SEM photograph showing the recycled carbon fibers of Example 4;

FIG. 2C is a SEM photograph showing the recycled carbon fibers of Example 10;

FIG. 3 is a set of diagrams illustrating the bending strength and bending modulus of carbon fiber reinforced plastic composed of virgin carbon fibers (vCFRP) and carbon fiber reinforced plastic composed of recycled carbon fibers (rCFRP);

FIG. 4 is a set of diagrams illustrating the tensile strength and tensile modulus of carbon fiber reinforced plastic composed of virgin carbon fibers (vCFRP) and carbon fiber reinforced plastic composed of recycled carbon fibers (rCFRP);

FIG. 5 is a diagram illustrating the interfacial shear strength of a virgin carbon fiber (vCF) and a recycled carbon fiber (rCF);

FIG. 6 is a diagram illustrating the tensile strength of a virgin carbon fiber (vCF) and a recycled carbon fiber (rCF);

FIG. 7 is a set of TEM photographs showing the fiber cross sections of a virgin carbon fiber (vCF) and a recycled carbon fiber (rCF);

FIG. 8 is a diagram showing EDX mapping of voids observed in the fiber cross sections of a virgin carbon fiber (vCF) and a recycled carbon fiber (rCF); and

FIG. 9 is a diagram illustrating the area ratio of D1 peak to G1 peak in the Raman spectra of Raman spectroscopic measurement of a virgin carbon fiber (vCF) and a recycled carbon fiber (rCF).

### MODE(S) FOR CARRYING OUT THE INVENTION

One or more embodiments of the present invention are directed to a method of recovering carbon fibers from carbon fiber reinforced plastics (CFRP) that have become waste materials or the like and a method of producing carbon fiber reinforced plastic using recycled carbon fibers recovered by the method of recovering carbon fibers. Hereinafter, examples of one or more modes for carrying out the present invention will be described with reference to the drawings. In the present specification and claims, when a range of numerical values is indicated as “x1 to x2,” it is assumed that the range includes both the numerical values x1 and x2 unless otherwise stated.

### «Method of Recovering Carbon Fibers»

The method of recovering carbon fibers of an embodiment of the present invention includes a first treatment step of immersing carbon fiber reinforced plastic in an acidic aqueous solution to dissolve at least a part of resin content of the carbon fiber reinforced plastic and a second treatment step of immersing a treated product subjected to the first treatment step in an alkaline aqueous solution having foaming properties to dissolve at least a part of resin content of the treated product.

The carbon fiber reinforced plastic as an object from which the carbon fibers are recovered is not particularly limited, but is preferably waste material, scrap material, or other carbon fiber reinforced plastic that is no longer in use. Carbon fibers are difficult to incinerate because they have a highly graphitized structure, and are disposed of in landfills as industrial waste. However, carbon fibers disposed of in landfills are not biodegradable, and become a cause of marine plastic pollution. Therefore, by recovering and recycling carbon fibers from such waste material and scrap material, the amount of waste material and scrap material disposed of in landfills can be reduced, thus contributing to the suppression of marine plastic pollution.

The acidic aqueous solution used in the first treatment step is not particularly limited, but an organic acid, an inorganic acid, or a mixture thereof can be used as the acid. Examples of organic acids include formic acid, acetic acid, and citric acid, while examples of inorganic acids include nitric acid, sulfuric acid, hydrochloric acid, and phosphoric acid. The acidic aqueous solution used in the first treatment step can be appropriately determined in consideration of the type of carbon fiber reinforced plastic as the object to be treated and the treatment conditions (mainly the treatment temperature and time). From the viewpoint of the solubility of the resin contained in the carbon fiber reinforced plastic, one or more of nitric acid and sulfuric acid are suitable and preferred because they are inexpensive and easily available.

The concentration of acid in the acidic aqueous solution used in the first treatment step can be appropriately determined in consideration of the type of acid, the type of carbon fiber reinforced plastic, the dissolution temperature, the dissolution time, etc. Although not particularly limited, the concentration of acid in the acidic aqueous solution used in the first treatment step can be in a range of 0.01 to 10 M (mol/l, here and hereinafter), and the temperature of the acidic aqueous solution can be in a range of 10° C. to 100° C. As an example of the first treatment step, it is preferred to immerse the carbon fiber reinforced plastic in a nitric acid aqueous solution having a temperature of 60° C. to 80° C. and a concentration of 4 to 8 M for 8 hours or more.

The alkaline aqueous solution having foaming properties used in the second treatment step is not particularly limited, but examples of the alkali include carbonates and hydrogen carbonates of alkali metals and carbonates and hydrogen carbonates of alkaline earth metals. Examples of the alkali metals include lithium, sodium, and potassium, and examples of the alkaline earth metals include beryllium, magnesium, and calcium. Among these, at least one of carbonates of alkali metals and hydrogen carbonates of alkali metals is more preferably contained, and at least one of sodium carbonate and sodium hydrogen carbonate is most preferably contained.

The alkaline aqueous solution having foaming properties used in the second treatment step is not particularly limited, but is more preferably an sodium carbonate aqueous solution or sodium hydrogen carbonate aqueous solution having a concentration of 0.005 to 0.1 M. The alkaline aqueous solution of the present embodiment has foaming properties and can therefore exhibit, in addition to the effect of removing the resin content by alkali, the effect of physically delaminating and removing the resin content from the surfaces of the carbon fibers due to the foaming action in the aqueous solution. Accordingly, even with an alkaline aqueous solution having a low concentration of about 0.005 to 0.1 M, carbon fibers without any resin residue can be recovered in a short time.

As an example of the second treatment step, it is preferred to immerse the treated product subjected to the first treatment step in an sodium carbonate aqueous solution or sodium hydrogen carbonate aqueous solution having a temperature of 60° C. to 80° C. and a concentration of 0.005 to 0.1 M for 1 to 120 minutes.

The alkaline aqueous solution having foaming properties used in the second treatment step may be an aqueous solution of the above alkali carbonate or alkali hydrogen carbonate alone, but may contain a foaming agent to further promote the foaming action. The foaming agent contained in the alkaline aqueous solution in the second treatment step is not particularly limited, but preferably contains at least one of a nonionic surfactant and an anionic surfactant.

Although not particularly limited, the anionic surfactant used as the foaming agent preferably contains at least one of a carboxylate, a sulfonate, a sulfate ester salt, and a phosphate ester salt, and the nonionic surfactant used as the foaming agent preferably contains at least one of polyethylene glycol and other polyhydric alcohols.

Although not particularly limited, the foaming agent used in the second treatment step may be contained in an amount of 0.05 to 5 weight % and preferably 0.1 to 1.0 weight % relative to the alkaline aqueous solution.

### «Method of Producing Carbon Fiber Reinforced Plastic Using Recycled Carbon Fibers»

The method of recovering carbon fibers as described above recovers carbon fibers with improved properties such as tensile strength compared to virgin carbon fibers. In the present specification, etc., the pure carbon fibers used in the carbon fiber reinforced plastic before recovery are called virgin carbon fibers, and the recovered carbon fibers are called recycled carbon fibers.

The recycled carbon fibers can be used to produce carbon fiber reinforced plastic. In particular, the recycled carbon fiber (single fiber) used in the present embodiment has higher mechanical properties such as tensile strength compared to virgin carbon fiber, as will be described later, and it is therefore possible to obtain carbon fiber reinforced plastic with higher bending strength, tensile strength, and interfacial shear strength compared to carbon fiber reinforced plastic using virgin carbon fibers. Known methods of producing carbon fiber reinforced plastic can be used without any modification as the method of producing carbon fiber reinforced plastic using recycled carbon fibers. Carbon fiber reinforced plastic can be produced by any of a method of producing a carbon fiber sheet and then compounding it with resin and a method of mixing resin and carbon fibers and then forming the mixture into a sheet.

As described above, the method of recovering carbon fibers of the present embodiment includes a first treatment step of immersing carbon fiber reinforced plastic in an acidic aqueous solution to dissolve at least a part of resin content of the carbon fiber reinforced plastic and a second treatment step of immersing a treated product subjected to the first treatment step in an alkaline aqueous solution having foaming properties to dissolve at least a part of resin content of the treated product. In particular, the alkaline aqueous solution has foaming properties and can therefore exhibit, in addition to the effect of removing the resin content by alkali, the effect of physically delaminating and removing the resin content from the surfaces of the carbon fibers due to the foaming action in the aqueous solution. Accordingly, even with an alkaline aqueous solution having a low concentration, carbon fibers without any resin residue can be recovered in a short time.

Moreover, in the method of recovering carbon fibers of the present embodiment, the alkaline aqueous solution contains at least one of an alkali carbonate and an alkali hydrogen carbonate and can therefore exhibit, in addition to the effect of removing the resin content by alkali, the effect of physically delaminating and removing the resin content from the surfaces of the carbon fibers due to the foaming action in the aqueous solution. Accordingly, even with a low concentration alkaline aqueous solution, carbon fibers without any resin residue can be recovered in a short time.

Furthermore, in the method of recovering carbon fibers of the present embodiment, the alkaline aqueous solution contains a foaming agent, and the foaming action of the alkaline aqueous solution can therefore be further promoted.

In addition, in the method of recovering carbon fibers of the present embodiment, the foaming agent contains at least one of a nonionic surfactant and an anionic surfactant, and the foaming action of the alkaline aqueous solution can therefore be further promoted.

Moreover, in the method of recovering carbon fibers of the present embodiment, the anionic surfactant contains at least one of a carboxylate, a sulfonate, a sulfate ester salt, and a phosphate ester salt, and the nonionic surfactant contains at least one of polyhydric alcohols; therefore, the foaming action of the alkaline aqueous solution can be further promoted.

Furthermore, in the method of recovering carbon fibers of the present embodiment, the alkaline aqueous solution having foaming properties is a sodium carbonate aqueous solution or sodium hydrogen carbonate aqueous solution having a concentration of 0.005 to 0.1 M and can therefore exhibit, in addition to the effect of removing the resin content by alkali, the effect of physically delaminating and removing the resin content from the surfaces of the carbon fibers due to the foaming action in the aqueous solution. Accordingly, even with a low concentration alkaline aqueous solution, carbon fibers without any resin residue can be recovered in a short time.

In addition, in the method of recovering carbon fibers of the present embodiment, the first treatment step includes immersing the carbon fiber reinforced plastic in a nitric acid aqueous solution having a temperature of 60° C. to 80° C. and a concentration of 4 to 8 M for 8 hours or more, and carbon fibers without any resin residue can therefore be recovered.

Moreover, in the method of recovering carbon fibers of the present embodiment, the second treatment step includes immersing the treated product subjected to the first treatment step in the sodium carbonate aqueous solution or sodium hydrogen carbonate aqueous solution having a temperature of 60° C. to 80° C. for 1 to 120 minutes, and carbon fibers without any resin residue can therefore be recovered in a short time.

In the method of producing carbon fiber reinforced plastic of the present embodiment, the carbon fiber reinforced plastic is produced using recycled carbon fibers recovered by the above method of recovering carbon fibers, and the mechanical properties such as tensile strength are higher than those of virgin carbon fibers. It is thus possible to obtain carbon fiber reinforced plastic with higher bending strength, tensile strength, and interfacial shear strength compared to carbon fiber reinforced plastic using virgin carbon fibers.

### Examples

Hereinafter, the present invention will be described with further specific examples, but the following numerical values, conditions, or the like do not limit the technical scope of the present invention.

### (A) Preparation of Samples

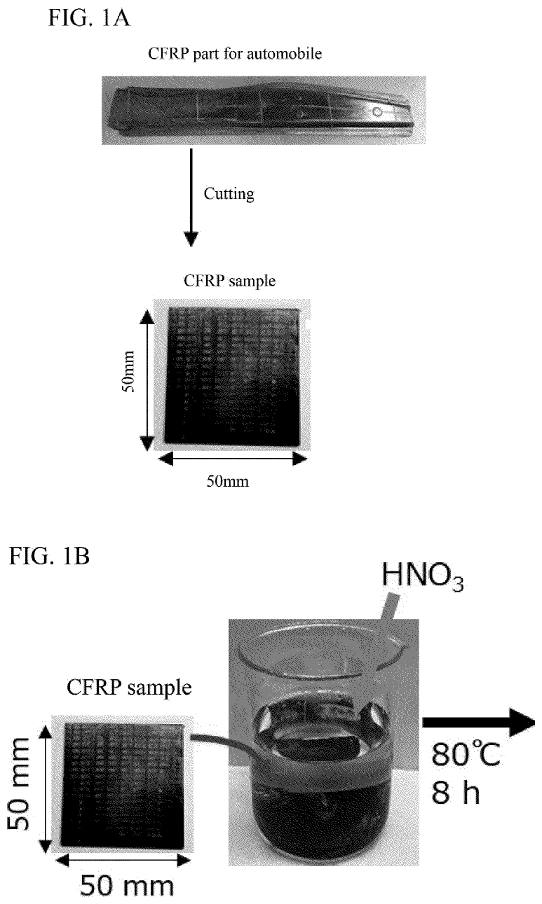

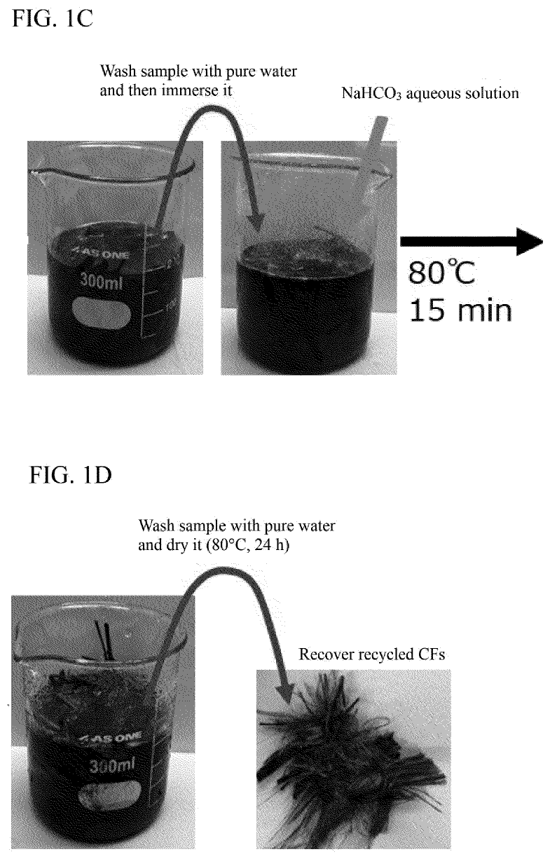

As illustrated in FIG. 1A, a waste carbon fiber reinforced plastic part for an automobile impregnated with epoxy resin was cut into pieces of a size of 50 mm×50 mm, which were used as carbon fiber reinforced plastic samples (referred to as CFRP samples, hereinafter).

### (B) Method of Recovering Recycled Carbon Fibers

As illustrated in FIG. 1B, the CFRP samples were each immersed in an aqueous solution of nitric acid (HNO₃) adjusted to a concentration of 8M for 8 to 48 hours (8 hours, 9 hours, 12 hours, 24 hours, or 48 hours) under an environment of 80° C. After that, as illustrated in FIG. 1D, the samples were taken out from the test tubes, washed with pure water, and then dried under an environment of 80° C. for 48 hours or more thereby to obtain recycled carbon fibers of Comparative Examples 1 to 5.

As illustrated in FIG. 1B, the CFRP samples were each immersed in an aqueous solution of nitric acid (HNO₃) adjusted to a concentration of 8M under an environment of 80° C. for 8 hours. Then, as illustrated in FIG. 1C, the samples were each taken out from the test tube and washed with pure water until the acidic aqueous solution was able to be removed. After that, as illustrated in FIG. 1C, the washed samples were each immersed in an aqueous solution of sodium hydrogen carbonate (NaHCO₃) adjusted to a concentration of 0.01 to 0.1 M (0.01 M or 0.1 M) under an environment of 80° C. for 1 to 90 minutes (1 minute, 5 minutes, 10 minutes, 15 minutes, 20 minutes, 30 minutes, or 90 minutes), and then the samples were taken out. The samples taken out were washed with pure water as illustrated in FIG. 1D, and then dried under an environment of 80° C. for 48 hours or more thereby to obtain recycled carbon fibers of Examples 1 to 7.

In addition, for comparative evaluation with Examples 1 to 7, the samples were each immersed in an aqueous solution of sodium hydroxide (NaOH) adjusted to a concentration of 1.0×10⁻⁶ M, rather than in an aqueous solution of nitric acid (HNO₃) illustrated in FIG. 1C, under an environment of 80° C. for 1 to 60 minutes (1 minute, 10 minutes, 20 minutes, or 60 minutes), and then the samples were taken out. The samples taken out were washed with pure water as illustrated in FIG. 1D, and then dried under an environment of 80° C. for 48 hours or more thereby to obtain recycled carbon fibers of Comparative Examples 6 to 9.

As illustrated in FIG. 1B, the CFRP samples were each immersed in an aqueous solution of nitric acid (HNO₃) adjusted to a concentration of 8M under an environment of 80° C. for 8 hours. Then, as illustrated in FIG. 1C, the samples were each taken out from the test tube and washed with pure water until the acidic aqueous solution was able to be removed. After that, as illustrated in FIG. 1C, an alkaline aqueous solution was prepared using an aqueous solution of sodium hydrogen carbonate (NaHCO₃) as an aqueous solution of alkali and either of surfactants as a foaming agent: sodium lauryl sulfate (SDS); polyethylene glycol (PEG) with molecular weight of 200 or 600; or a mixture of sodium lauryl sulfate and polyethylene glycol with molecular weight of 200. The concentration of the sodium hydrogen carbonate aqueous solution was adjusted to 0.01 M, and the concentration of the surfactant as a foaming agent was adjusted to 0.1 weight % to 1 weight % by (0.1 weight % or 1.0 weight %). Then, as illustrated in FIG. 1C, the samples were each immersed in the alkaline aqueous solution under an environment of 80° C. for 10 to 60 minutes (10 minutes or 60 minutes), and then the samples were taken out. The samples taken out were washed with pure water as illustrated in FIG. 1D, and then dried under an environment of 80° C. for 48 hours or more thereby to obtain recycled carbon fibers of Examples 8 to 15.

As illustrated in FIG. 1B, the CFRP samples were each immersed in an aqueous solution of nitric acid (HNO₃) adjusted to a concentration of 8M under an environment of 80° C. for 8 hours. Then, as illustrated in FIG. 1C, the samples were each taken out from the test tube and washed with pure water until the acidic aqueous solution was able to be removed. After that, sodium lauryl sulfate (SDS), a surfactant, was used as a foaming agent to prepare its aqueous solutions adjusted to concentrations of 0.1% and 0.3%, and the samples were immersed in the solutions under an environment of 80° C. for 20 minutes and then taken out. The samples taken out were washed with pure water as illustrated in FIG. 1D, and then dried under an environment of 80° C. for 48 hours or more thereby to obtain recycled carbon fibers of Comparative Examples 10 to 11.

(C) Evaluation of Resin Decomposition Rate from Recycled Carbon Fibers

### (C-1) Evaluation Method

The CFRP sample was immersed in each of the above-described solutions, and the change over time in a resin decomposition rate Rd (mass %) of the obtained recycled carbon fibers was calculated using Equation 1 below.

$$R d = ( {m}_{0} - {m}_{t} ) / {m}_{0} \cdot Fm \times 100 \qquad ( Equation 1 )$$

Here, m₀ is the mass of the sample before immersion in the nitric acid solution, mₜ is the mass of the recycled carbon fiber sample, and Fm is the mass fraction of the resin impregnated in the CFRP sample.

The mass fraction of the resin impregnated in the CFRP sample (Fm) was experimentally obtained through heat treating the CFRP sample and measuring the change in the mass of the sample before and after thermal decomposition. As a result, the mass of the CFRP sample before heating was 1.2772 g, while the mass of the CFRP after heating decreased to 0.7692 g. From the above results, Fm=(1−0.7692÷1.2772)×100=39.77% was obtained. Furthermore, this experiment was repeated multiple times, and it has been confirmed that Fm=40.0% is exhibited.

### (C-2) Evaluation Results and Considerations

The change over time in the resin decomposition rate was calculated using Formula 1 above for each sample of Examples 1 to 15 and Comparative Examples 1 to 11. The results are listed in Table 1.

TABLE 1

| | | | | | | | | | | Recycled |
|---|---|---|---|---|---|---|---|---|---|---|
| | | | | | | | | | | carbon |
| | | | | | | | | | | fibers |
| | | | | | | | | | | recovered |
| | | | | | | | | | | Resin |
| | | | | | | | | | | decom- |
| | First treatment step | | | Second treatment step | | | | | | position |
| | Treatment | | Immersion | Treatment | | Immersion | Treatment | | Immersion | rate |
| | liquid | Concentration | time | liquid 1 | Concentration | time | liquid 2 | Concentration | time | (mass %) |
| Comparative | Nitric | 8M | 8 h | — | | | — | | | 75.8 |
| Example 1 | acid | | | | | | | | | |
| Comparative | aqueous | | 9 h | | | | | | | 80.1 |
| Example 2 | solution | | | | | | | | | |
| Comparative | | | 12 h | | | | | | | 89.1 |
| Example 3 | | | | | | | | | | |
| Comparative | | | 24 h | | | | | | | 94.9 |
| Example 4 | | | | | | | | | | |
| Comparative | | | 48 h | | | | | | | 95.3 |
| Example 5 | | | | | | | | | | |
| Example 1 | Nitric | 8M | 8 h | Sodium | 0.1M | 1 min | — | | | 81.3 |
| Example 2 | acid | | | hydrogen | | 5 min | | | | 89.0 |
| Example 3 | aqueous | | | carbonate | | 10 min | | | | 92.5 |
| Example 4 | solution | | | aqueous | | 15 min | | | | 96.4 |
| Example 5 | | | | solution | | 20 min | | | | 98.5 |
| Example 6 | | | | | | 30 min | | | | 99.3 |
| Example 7 | | | | | 0.01M | 90 min | | | | 96.6 |
| Comparative | | | | Sodium | 1.0 × 10⁻⁶M | 1 min | | | | 81.3 |
| Example 6 | | | | hydroxide | | | | | | |
| Comparative | | | | aqueous | | 10 min | | | | 82.0 |
| Example 7 | | | | solution | | | | | | |
| Comparative | | | | | | 20 min | | | | 92.4 |
| Example 8 | | | | | | | | | | |
| Comparative | | | | | | 60 min | | | | 96.6 |
| Example 9 | | | | | | | | | | |
| Example 8 | Nitric | 8M | 8 h | Sodium | 0.01M | — | SDS | 0.10% | 10 min | 85.0 |
| Example 9 | acid | | | hydrogen | | | | | 60 min | 99.0 |
| Example 10 | aqueous | | | carbonate | | | | 1.00% | 10 min | 97.0 |
| Example 11 | solution | | | aqueous | | | PEG | 0.10% | 60 min | 95.9 |
| Example 12 | | | | solution | | | (molecular | 1.00% | 10 min | 97.6 |
| | | | | | | | weight of | | | |
| | | | | | | | 200) | | | |
| Example 13 | | | | | | | PEG | 0.10% | 60 min | 96.9 |
| Example 14 | | | | | | | (molecular | 1.00% | 10 min | 99.7 |
| | | | | | | | weight of | | | |
| | | | | | | | 600) | | | |
| Example 15 | | | | | | | SDS-PEG | Each 0.1% | 10 min | 96.9 |
| | | | | | | | (molecular | | | |
| | | | | | | | weight of | | | |
| | | | | | | | 200) | | | |
| Comparative | Nitric | 8M | 8 h | — | | | SDS | 0.10% | 20 min | 81.5 |
| Example 10 | acid | | | | | | | | | |
| Comparative | aqueous | | | | | | | 0.30% | 20 min | 80.1 |
| Example 11 | solution | | | | | | | | | |

In Comparative Examples 1 to 5, Rd=75.8 mass % after 8 hours of immersion in the nitric acid aqueous solution, Rd=89.1 mass % after 12 hours, Rd-94.9 mass % after 24 hours, and Rd=95.3 mass % after 48 hours were exhibited. Thus, there was almost no change in the resin decomposition rate after 24 hours, and it is therefore considered that most of the resin was decomposed in 24 hours.

In Examples 1 to 7, after immersion in the nitric acid aqueous solution for 8 hours, immersion in 0.1 M sodium hydrogen carbonate aqueous solution for 15 minutes showed Rd=96.4 mass %. When the concentration of the sodium hydrogen carbonate solution was reduced to 0.05 M and 0.01 M, immersion for about 60 minutes at 0.05 M and about 90 minutes at 0.01 M showed values of Rd=95 mass % or more.

On the other hand, in the cases of Comparative Examples 6 to 9 using the sodium hydroxide solution, even though the aqueous solution was the same weak alkaline solution, the resin decomposition was slow, and it took 20 minutes or more for Rd to show 95 mass % or more. According to the comparison results between Examples 1 to 7 and Comparative Examples 6 to 9, it is considered that in Examples 1 to 7, in addition to dissolving the resin content with alkali, the sodium hydrogen carbonate aqueous solution foamed under an environment of 80° C., and the resin was physically delaminated, thereby allowing the resin to be removed in a short time.

In addition, according to the comparison results between Comparative Examples 1 to 5 and Examples 1 to 7, recycled carbon fibers with no resin residue were obtained in Examples 1 to 7 to have Rd of 95 mass % in about 8.2 to 9.5 hours, thus demonstrating that this method can significantly shorten the recovery time.

In Examples 8 to 15, it was confirmed that by using a sodium hydrogen carbonate aqueous solution in combination with a foaming agent (surfactant such as sodium lauryl sulfate (SDS) or polyethylene glycol), Rd-95 mass % or more was achieved in a short time even under a condition of a low concentration of sodium hydrogen carbonate aqueous solution, such as 0.01 M.

In Comparative Examples 10 and 11, the resin decomposition rate did not increase significantly, thus indicating that a foaming agent such as surfactant alone without an alkaline aqueous solution does not effectively act to decompose and remove resin in a short time.

(D) Surface Observation of Virgin Carbon Fibers (vCF) and Recycled Carbon Fibers (rCF)

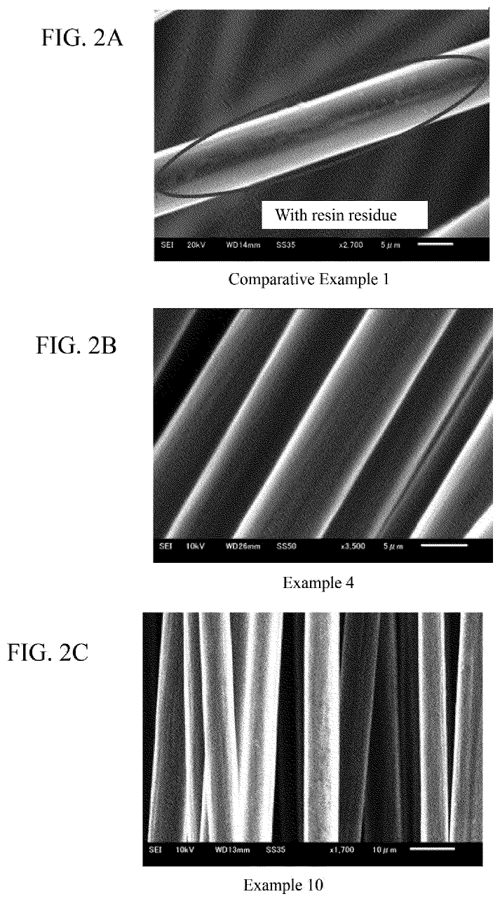

FIGS. 2A to 2C show the results of observing the surfaces of virgin carbon fibers (also referred to as vCF or vCFs, hereinafter) and recycled carbon fibers (also referred to as rCF or rCFs, hereinafter) by scanning electron microscope (SEM).

FIG. 2A is a scanning electron microscope photograph showing the recycled carbon fibers of Comparative Example 1, which were immersed in a nitric acid aqueous solution for 8 hours and then recovered, and resin residue was confirmed on the carbon fiber surfaces. FIG. 2B is a scanning electron microscope photograph showing the recycled carbon fibers of Example 4, which were immersed in a nitric acid aqueous solution for 8 hours, thereafter immersed in a 0.1 M sodium hydrogen carbonate aqueous solution for 15 minutes, and then recovered, and clean carbon fibers without resin residue were recovered. FIG. 2C is a scanning electron microscope photograph showing the recycled carbon fibers of Example 10, which were immersed in a nitric acid aqueous solution for 8 hours, thereafter immersed for 10 minutes in a low-concentration 0.1 M sodium hydrogen carbonate aqueous solution with 1.0 weight % of sodium lauryl sulfate added, and then recovered, and clean carbon fibers without resin residue were recovered despite the low-concentration alkaline aqueous solution and the short time.

(E) Method of Preparing Carbon Fiber Reinforced Plastic (rCFRP) Using Recycled Carbon Fibers

The above-described recycled carbon fibers of Example 4 were used to prepare a dry nonwoven fabric. In addition, a dry nonwoven fabric was prepared using virgin carbon fibers for comparative evaluation. The nonwoven fabrics thus prepared were set in respective 250×200 mm molds, and impregnated with epoxy resin under conditions of a mold temperature of 120° C., molding pressure of 20 t, and curing time of 5 minutes to prepare a CFRP molded plate composed of recycled carbon fibers (also referred to as rCFRP, hereinafter) and a CFRP molded plate composed of virgin carbon fibers (also referred to as vCFRP, hereinafter).

### (F) Three-Point Bending Test of CFRP

### (F-1) Evaluation Method

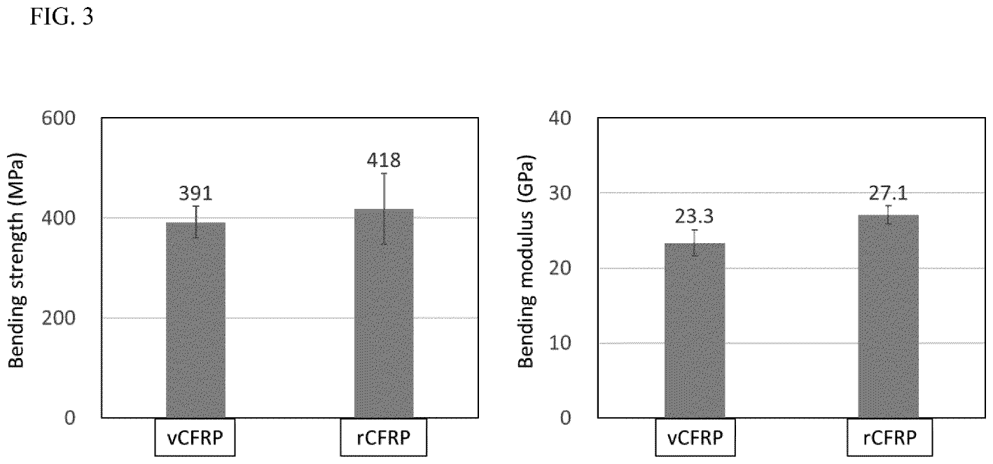

Three-point bending test was carried out based on JIS K 7074-1988 (Testing Methods for Flexural Properties of Carbon Fiber Reinforced Plastics) to evaluate the bending strength and bending modulus. In carrying out the three-point bending test, a test piece having a length of 100 mm and a width of 15 mm was cut out from a CFRP molded plate having a size of 250×200 mm, and the test was carried out at a bending speed of 5 mm/min. The evaluation results of the three-point bending test are illustrated in FIG. 3. The vertical axis in the left diagram of FIG. 3 represents the bending strength (MPa), and the vertical axis in the right diagram of FIG. 3 represents the bending modulus (GPa).

### (F-2) Evaluation Results

As illustrated in FIG. 3, vCFRP showed bending strength of 391±32 MPa and bending modulus of 23.3±1.7 GPa, while rCFRP showed bending strength of 418±16 MPa and bending modulus of 27.1±1.2 GPa. It has thus been confirmed that the bending strength of rCFRP increases by about 1.1 times that of vCFRP, and the bending modulus of rCFRP increases by about 1.2 times that of vCFRP.

### (G) Tensile Test of CFRP

### (G-1) Evaluation Method

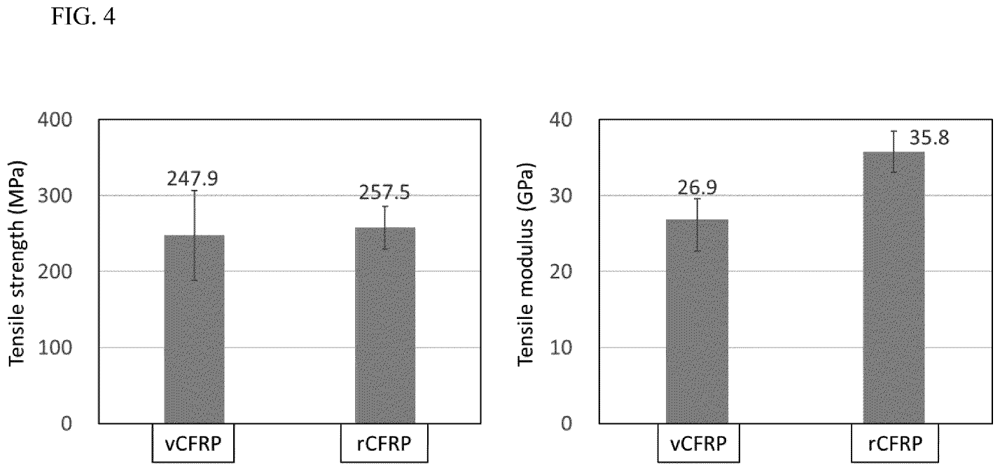

Tensile test was carried out based on JIS K 7083-1993 (constant-load amplitude tension of carbon fiber reinforced plastics) to evaluate the tensile strength and tensile modulus. In carrying out the tensile test, a test piece having a length of 200 mm and a width of 25 mm was cut out from a CFRP plate having a size of 250×200 mm, and the test was carried out at a tensile speed of 2 mm/min. The evaluation results of the tensile test are illustrated in FIG. 4. The vertical axis in the left diagram of FIG. 4 represents the tensile strength (MPa), and the vertical axis in the right diagram of FIG. 4 represents the tensile modulus (GPa).

### (G-2) Evaluation Results

As illustrated in FIG. 4, vCFRP showed a tensile strength of 248±59 MPa and a tensile modulus of 26.9±4.2 GPa, while rCFRP showed a tensile strength of 258±35 MPa and a tensile modulus of 35.8±2.7 GPa. It has thus been confirmed that the tensile strength of rCFRP is approximately the same as that of vCFRP, and the tensile modulus of rCFRP increases by about 1.3 times that of vCFRP.

### (H) Evaluation of Quality of Single Fiber

To evaluate the quality of a single fiber, observation and evaluation of the carbon fiber cross section were carried out using a microdroplet test to measure the interfacial shear strength between the fiber and resin, a single fiber strength test, an X-ray photoelectron spectroscopic (XPS) measurement, and energy dispersive X-ray spectroscopy (TEM-EDX). Two types of carbon fibers were evaluated: vCF and rCF. For rCF, the recycled carbon fiber recovered in Example 4 was used.

### (I) Microdroplet Test

### (I-1) Evaluation Method

The interfacial adhesion between the carbon fiber and the epoxy resin was evaluated by conducting a microdroplet test on each of vCF and rCF. The single fiber pull-out speed in the microdroplet test was set to 0.12 mm/min. In the measurement, a maximum load F (mN) when the resin droplet was pulled out was measured, and an interfacial shear strength t (MPa) was calculated using Equation 2 below.

$$τ = F / π dL \times {10}^{3} \qquad ( Equation 2 )$$

Here, F is the measured maximum load (mN), d is the carbon fiber diameter (standard value, d=7.0 μm), and L is the diameter of the resin droplet (measured value, 70 to 90 μm).

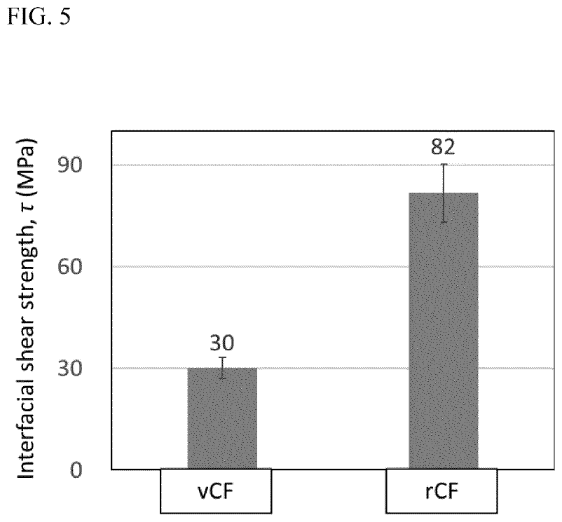

It has been reported that there is a positive correlative relationship between the interfacial shear strength t and the diameter L of the resin droplet, and the interfacial shear strength value for resin droplets of the same size was therefore calculated through plotting the measured t values against the diameters L of the resin droplets used in the measurement to obtain a linear regression equation and calculating the interfacial shear strength t corresponding to a resin droplet of 70 μm. FIG. 5 illustrates the evaluation results of the interfacial shear strengths by the microdroplet test. The vertical axis of FIG. 5 represents the interfacial shear strength (MPa).

### (I-2) Evaluation Results

As illustrated in FIG. 5, the interfacial shear strength t of vCF was 30±3.1 MPa while that of rCF was 82=8.6 MPa, and it has been confirmed that the interfacial shear strength of rCF increases even by 2.7 times that of vCF.

### (J) Quantification Test of Amount of Functional Groups on Carbon Fiber Surface by X-Ray Photoelectron Spectroscopic (XPS) Measurement

Elemental analysis using X-ray photoelectron spectroscopy (XPS) was conducted to calculate the composition ratio of functional groups contained in each sample. The results are listed in Table 2. Among these functional groups, those involved in the bond with the resin are indicated in gray hatching in Table 2 (C—OH, C—O—C, >C═O, —CO—O—, —NH₂, —NO/NH₄, —NO₂, and O). The results of calculating the abundance ratio of these functional groups involved in the bond with the resin are indicated in the bottom row of Table 2. In vCF, the abundance of functional groups involved in the bond with the resin was 52.2%, while in rCF, the abundance of functional groups involved in the bond with the resin was 63.2%, and it has thus been confirmed that the abundance of functional groups involved in the bond with the resin increases in rCF. A correlation was recognized between the abundance of functional groups involved in the bond with the resin and the value of the interfacial shear strength with the resin illustrated in FIG. 5, and it has thus been found that the functional groups derived from nitric acid are added to the carbon fiber surfaces during the carbon fiber recovery process.

TABLE 2

| | | vCF | rCF |
|---|---|---|---|
| C (%) | CHn | 45.1 | 35.8 |
| | C—OH, C—O—C | 27.8 | 28.5 |
| | >C═O | 2.8 | 3.3 |
| | —CO—O— | 0.8 | 1.6 |
| | —C═C— | 0.7 | 0.8 |
| | Total | 77.2 | 70.1 |
| N (%) | —NH₂ | 0.0 | 3.3 |
| | —NO/NH₄ | 1.2 | 0.9 |
| | —NO₂ | 0.0 | 4.1 |
| | Total | 1.2 | 8.3 |
| O (%) | | 19.5 | 21.5 |
| Others (%) | | 1.9 | 0.2 |

| | | |
|---|---|---|
| Abundance of functional groups involved in | 52.2 | 63.2 |
| bond with resin (%) | | |

### (K) Tensile Test of Carbon Fiber

### (K-1) Evaluation Method

Tensile test for vCF and rCF single fibers was carried out based on JIS R 7606 (Carbon fibre-Determination of the tensile properties of the single-filament specimens). Both ends of each single fiber sample were pulled at a pulling speed of 1 mm/min, a maximum load F′ (mN) measured by the testing machine when the single fiber broke was recorded, and a tensile strength σ (GPa) was evaluated using Equation 3 below.

$$σ = 4 {F}^{′} / π {d}^{2} \qquad ( Equation 3 )$$

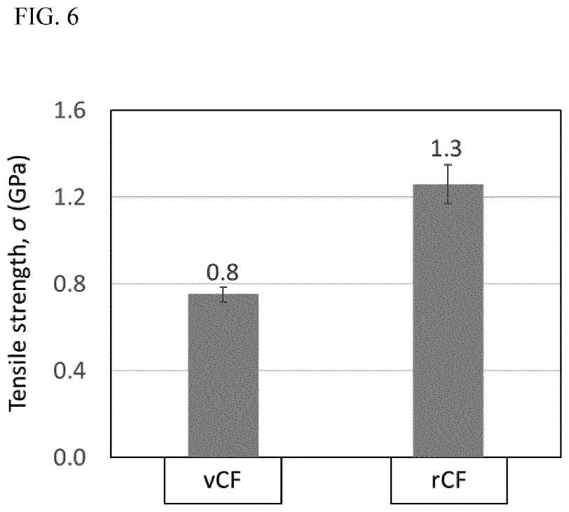

Here, F′ is the maximum load (mN) measured when the single fiber broke, and d is the carbon fiber diameter (standard value, d=7.0 μm). FIG. 6 illustrates the evaluation results of the tensile test of carbon fibers. The vertical axis of FIG. 6 represents the tensile strength σ (GPa).

### (K-2) Evaluation Results

The tensile strength of the single fiber was σ=0.75±0.007 GPa for vCF, whereas 0=1.26±0.089 GPa for rCF. Here, the variation in tensile strength values was calculated as the standard deviation value when approximating the data to the Weibull distribution. As in the phenomenon observed in the interfacial shear strength between the fiber and the resin, the tensile strength of rCF in the single fibers increased even by 1.7 times that of vCF.

### (L) Observation of Carbon Fiber Cross Section

### (L-1) Evaluation Method

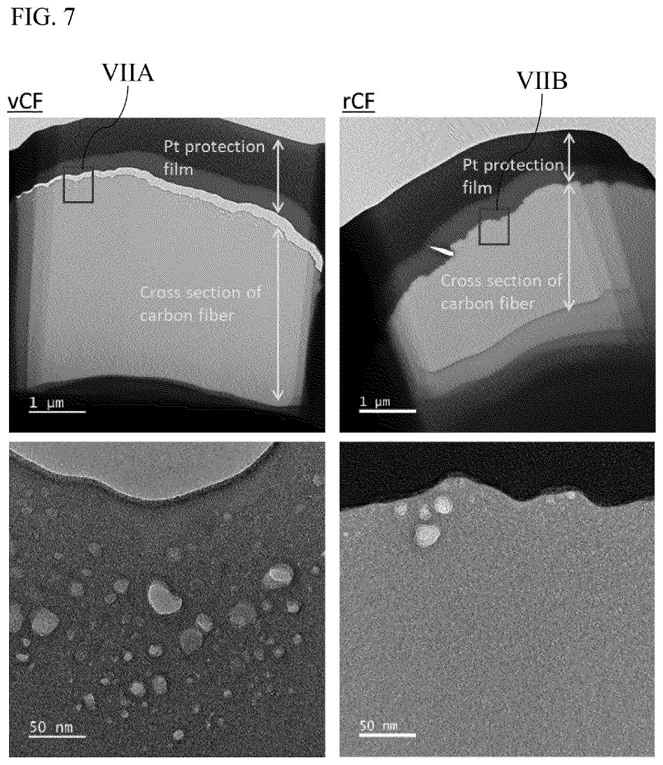

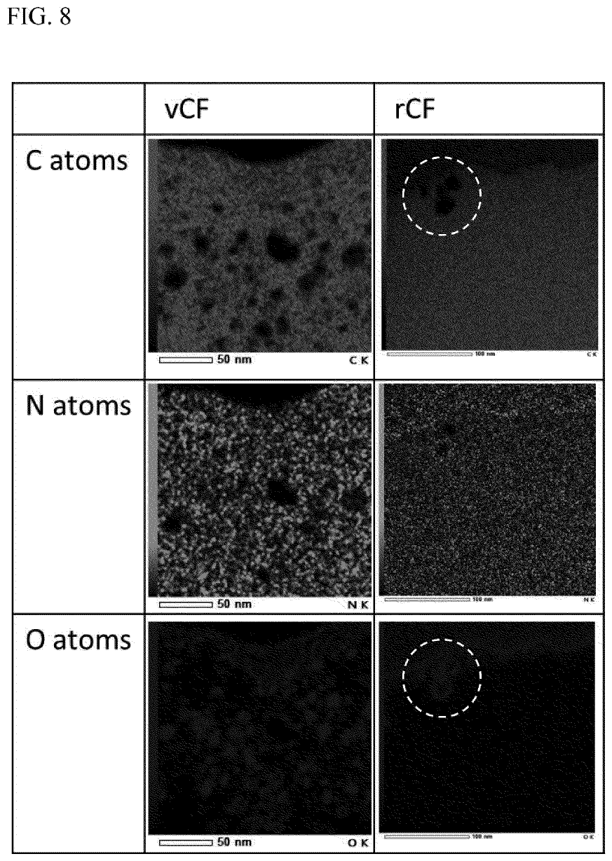

In order to observe the carbon fiber cross section, a cross section having a thickness of about 100 nm was prepared using focused ion beam (FIB) processing. The prepared cross section was observed using a transmission electron microscope (TEM), and the element distribution in the cross section was observed using an energy dispersive X-ray spectrometer (EDX). FIG. 7 shows the results of performing TEM observation of the carbon fiber cross sections. The upper left of FIG. 7 shows a TEM photograph of vCF, and the lower left shows an enlarged photograph of part VIIA. The upper right of FIG. 7 shows a TEM photograph of rCF, and the lower right shows an enlarged photograph of part VIIB.

### (L-2) Evaluation Results

From the TEM observation results of vCF shown in FIG. 7, voids were confirmed in a region 400 nm inside from the carbon fiber surface, and their size was about 1 to 30 nm. In contrast, regarding the TEM observation results of rCF, the amount of voids present decreased than that of vCF, and the voids were present in a region 50 nm inside from the surface, which was an extreme surface layer portion as compared to vCF.

Here, Table 3 lists the results of quantifying the presence ratios of voids in the cross sections of the observed carbon fibers using Image J image analysis software. As a result, it was shown that the amount of voids present in rCF (0.73%) decreased one-third or less of the amount of voids present in vCF (3.21%). This is thought to be because the voids were removed together with the graphite structure of the surface layer by the nitric acid in the first treatment step.

TABLE 3

| | Presence ratio of voids |
|---|---|
| vCF | 3.21% |
| rCF | 0.73% |

Then, FIG. 8 shows the results of performing EDX mapping on the observed void portions with the target elements C (carbon), N (nitrogen), and O (oxygen). In an EDX mapping image, void portions in which no elements are present are shown in black. As illustrated in FIG. 8, not only C (carbon) but also N (nitrogen) and O (oxygen) were unconfirmed in the void portions (black portions) of vCF. In contrast, C (carbon) was unconfirmed in the void portions of rCF as in vCF, but O (oxygen) was confirmed to be present in the void portions in a dense manner. In other words, when taking a look at the EDX mapping image of rCF with the C element as the target element in FIG. 8, about three large circular black sites in which no C element is present are observed in the upper left portion indicated by the dashed circle. In contrast, in the EDX mapping image of the same field of view with O element as the target element, the color representing O element is strongly observed at the same position indicated by the dashed circle. This indicates that O element is present in this portion in a dense manner and oxygen is present in the void portions.

From the results of the cross-sectional observation of the carbon fibers above, the following two factors can be mentioned as reasons why the tensile strength of the recycled carbon fiber is improved compared to the virgin carbon fiber. First, the amount of voids present decreased in rCF. It is known that the carbon fiber is a brittle material and its strength is greatly affected by defects on the fiber surface and inside. According to previous reports, it has been confirmed that the smaller the void diameter inside the fiber, the more improved the fiber strength. It is therefore thought that in fibers with improved tensile strength, the reduction in the amount of voids present reduces the number of starting points of stress concentration when a tensile load is applied, leading to the improvement of tensile strength.

Second, because functional groups containing at least either oxygen or nitrogen were incorporated into the voids, the number of starting points when a tensile load was applied to the carbon fiber was able to be reduced, which is thought to have led to improved tensile strength compared to virgin carbon fibers that had not been treated in any way.

### (M) Evaluation of Graphite Structure of Carbon Fibers

### (M-1) Evaluation Method

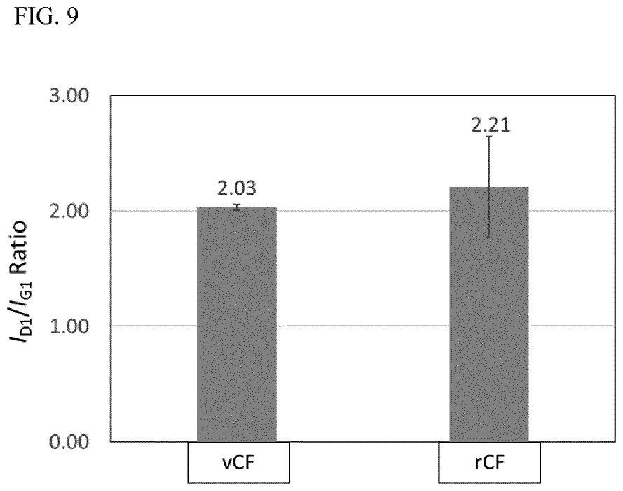

Raman spectroscopic measurement was conducted to calculate the areas of G1 and D1 peaks in the obtained Raman spectrum. The G1 peak represents a peak derived from a six-membered carbon ring structure (high crystallinity), and the D1 peak represents a peak derived from structural disorder (low crystallinity) such as partial cleavage of the six-membered carbon ring, so the graphite structure was evaluated by calculating a peak area ratio of D1/G1. The results are listed in FIG. 9. The vertical axis of FIG. 9 represents the peak area ratio of D1/G1.

### (M-2) Evaluation Results

As illustrated in FIG. 9, the peak area ratio of rCF did not change significantly compared to the peak area ratio of vCF, indicating that there was no disorder of the graphite structure or a decrease in the crystallinity due to recycling.

1. A method of recovering carbon fibers comprising:
immersing carbon fiber reinforced plastic in an acidic aqueous solution to dissolve at least a part of resin content of the carbon fiber reinforced plastic; and
immersing a treated product subjected to the immersing the carbon fiber reinforced plastic in the acidic aqueous solution in an alkaline aqueous solution having foaming properties to dissolve at least a part of resin content of the treated product.

2. The method of recovering carbon fibers according to claim 1, wherein the alkaline aqueous solution contains at least one of an alkali carbonate and an alkali hydrogen carbonate.

3. The method of recovering carbon fibers according to claim 1, wherein the alkaline aqueous solution contains a foaming agent.

4. The method of recovering carbon fibers according to claim 3, wherein the foaming agent contains at least one of a nonionic surfactant and an anionic surfactant.

5. The method of recovering carbon fibers according to claim 4, wherein
the anionic surfactant contains at least one of a carboxylate, a sulfonate, a sulfate ester salt, and a phosphate ester salt, and
the nonionic surfactant contains at least one of polyhydric alcohol s.

6. The method of recovering carbon fibers according to claim 1, wherein the alkaline aqueous solution is a sodium carbonate aqueous solution or sodium hydrogen carbonate aqueous solution having a concentration of 0.005 to 0.1 M.

7. The method of recovering carbon fibers according to claim 6, wherein the immersing the carbon fiber reinforced plastic in the acidic aqueous solution includes immersing the carbon fiber reinforced plastic in a nitric acid aqueous solution having a temperature of 60° C. to 80° C. and a concentration of 4 to 8 M for 8 hours or more.

8. The method of recovering carbon fibers according to claim 6, wherein the immersing the treated product in the alkaline aqueous solution includes immersing the treated product in the sodium carbonate aqueous solution or sodium hydrogen carbonate aqueous solution having a temperature of 60° C. to 80° C. for 1 to 120 minutes.

9. A method of producing carbon fiber reinforced plastic using recycled carbon fibers recovered by the method of recovering carbon fibers according to claim 1.
